(19) United States
(12) Patent Application Publication
(10) Pub. No.: US 2013/0083545 A1
(43) Pub. Date: Apr. 4, 2013

(54) ILLUMINATION DEVICE INCORPORATING PIN AND TAB FOR ELECTRICAL CONNECTION

(71) Applicant: MIN-JET LUI, Chu-Nan (TW)

(72) Inventor: MIN-JET LUI, Chu-Nan (TW)

(73) Assignee: FOXSEMICON INTEGRATED TECHNOLOGY, INC., Chu-Nan (TW)

(21) Appl. No.: 13/594,855

(22) Filed: Aug. 26, 2012

(30) Foreign Application Priority Data
Sep. 29, 2011 (TW) 100135166

(51) Int. Cl. F21V 3/00

(52) U.S. Cl. 362/363

(57) ABSTRACT

An illumination device includes a cap, a holder fixed to the cap, a housing fixed to the holder, a driving module received in the housing, a light source mounted on the housing and a cover secured on the housing and covering the light source. The cap includes an electrically conductive column and an electrical contact tip. The contact tip is electrically insulative from the column The driving module includes a plate, a plurality of electronic components mounted on the plate, two upper pins extending upwardly from the plate, a lower pin extending downwardly from the plate and a tab extending laterally from the plate. The upper pins extend through the housing into the light source to electrically connect with the light source. The lower pin and the tab separably contact the contact tip and the column, respectively.

### BACKGROUND

1. Technical Field

The present disclosure relates to illumination devices, and more particularly, to an illumination device incorporating pins and a tab for electrical connection.

2. Description of Related Art

As a new type of light source, LEDs are widely used in various applications. A typical LED bulb includes a head, a housing fixed to the head, a plurality of LEDs fixed to the housing, a driving module received in the housing and a cover mounted to the housing to cover the LEDs. The driving module electrically connects the LEDs with the head. In use, the head of the bulb is fittingly engaged with a conventional bulb socket for providing power to the LEDs.

Generally, the driving module is electrically connected to the LEDs and the head through a plurality of wires. However, the wires are required to be soldered to the driving module, the LEDs and the head to realize the electrical connection therebetween. Such soldering process of the wires causes the assembly of the bulb to become inconvenient and time-consuming.

What is needed, therefore, is an illumination device which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an illumination device in accordance with an embodiment of the present disclosure.

FIG. 2 is an exploded view of the illumination device of FIG. 1.

FIG. 3 is an inverted view of the illumination device of FIG. 2.

FIG. 4 is a cross sectional view of the illumination device of FIG. 1 taken along line IV-IV thereof.

FIG. 5 is a cross sectional view of the illumination device of FIG. 1 taken along line V-V thereof.

### DETAILED DESCRIPTION OF THE EMBODIMENTS

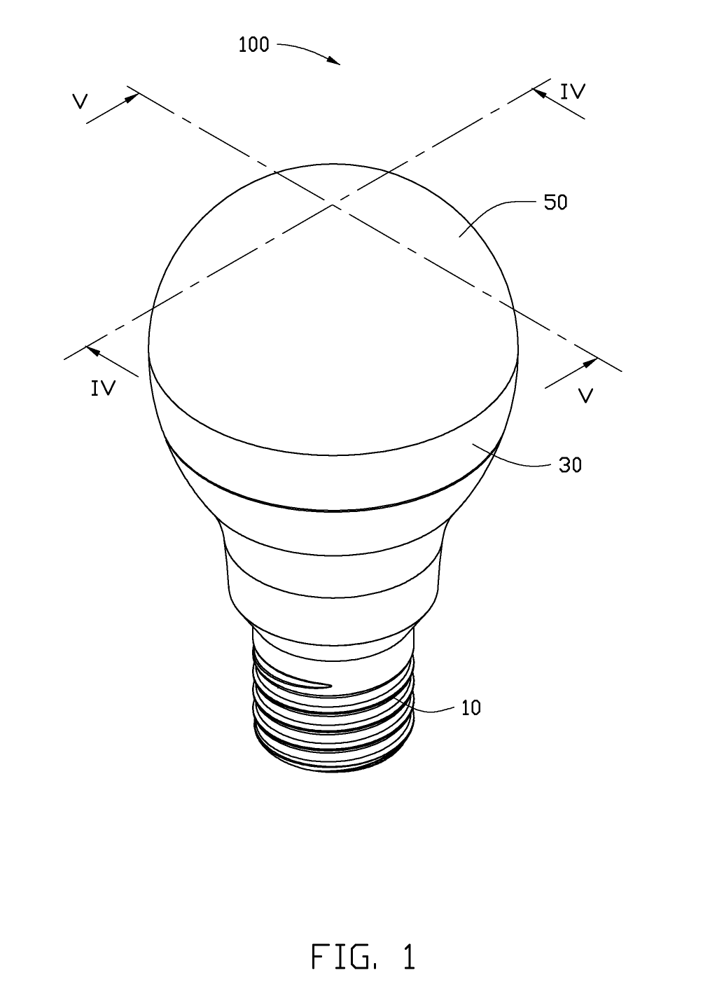

Referring to FIG. 1, an illumination device 100 in accordance with an embodiment of the present disclosure is shown. In this embodiment the illumination device 100 is an LED bulb 100. The LED bulb 100 includes a head 10, a cover 50 and a housing 30 connecting the cover 50 with the head 10.

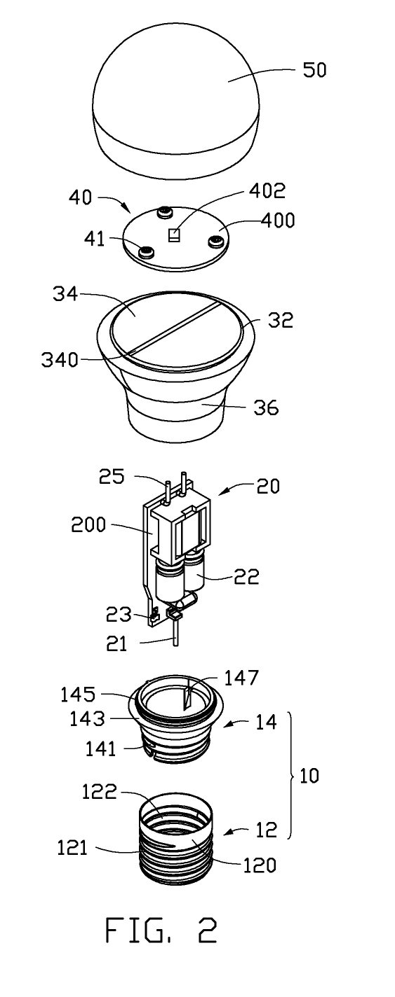

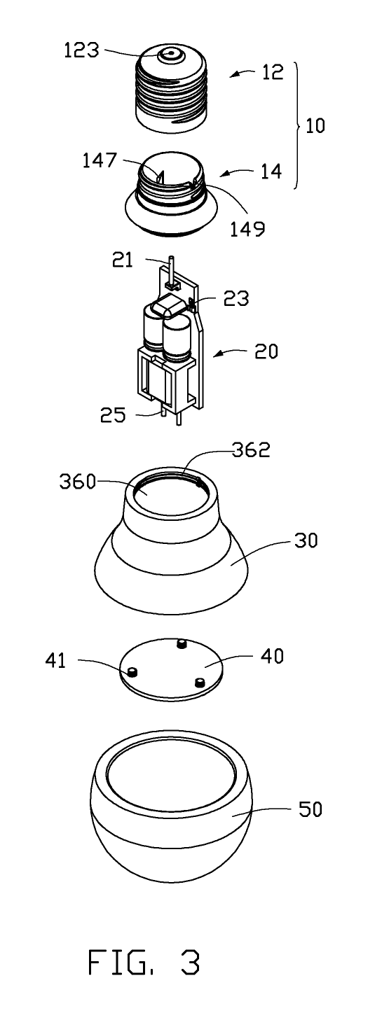

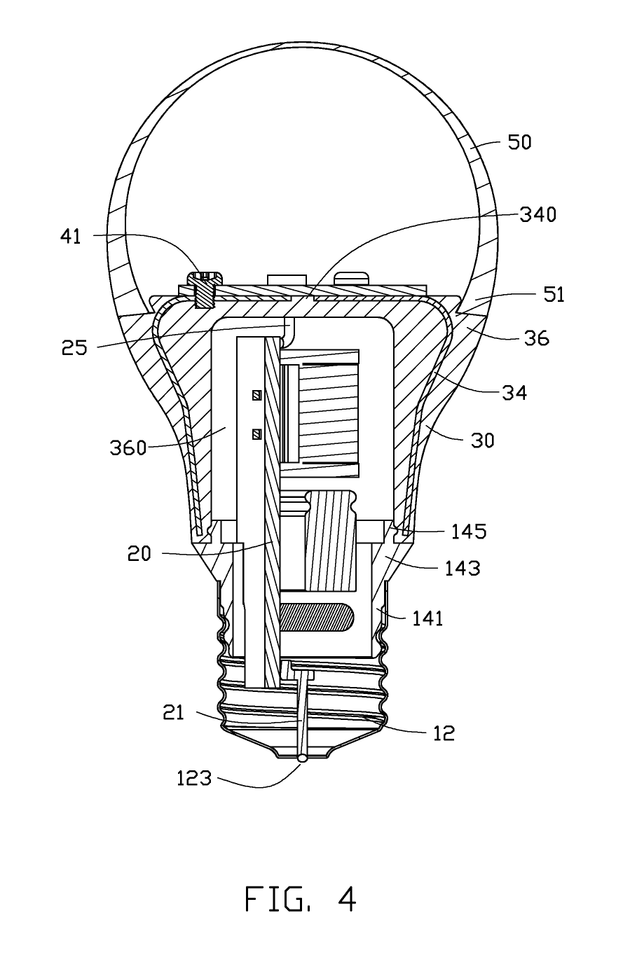

Also referring to FIGS. 2-3, the head 10 includes a cap 12 and a holder 14 separably connecting with the cap 12. The cap 12 includes a hollow column 120 having a top opening and a sealed bottom end. The column 120 of the cap 12 is integrally made of conductive materials such as metal. The cap 12 has a plurality of outer threads 121 formed around an outer circumferential face of the column 120 and a plurality of inner threads 122 formed around an inner circumferential face of the column 120. A contact tip 123 is formed on the bottom end of the column 120 of the cap 12. The contact tip 123 is made of electrically conductive materials such as metal. The contact tip 123 is connected to the bottom end of the column 120 of the cap 12 through an insulative ring (not labeled) so that the contact tip 123 is not electrically connected to the column 120 of the cap 12. The holder 14 is made of insulative materials such as plastic. The holder 14 is hollow with a bottom opening and top opening. The holder 14 includes a base 143, an upper engaging flange 145 extending upwardly from the base 143 and a lower engaging flange 141 extending downwardly from the base 143. The base 143 has an outer diameter gradually increasing upwardly and a constant inner diameter (see FIG. 4). The base 143 defines two slots 147 in an inner circumferential face thereof. The two slots 147 are located adjacent to the upper engaging flange 145 and opposite to each other. The upper engaging flange 145 and the lower engaging flange 141 each have a plurality of outer threads (not labeled) formed on an outer circumferential face thereof. The upper engaging flange 145 has a height less than that of the lower engaging flange 141. The outer threads of the lower engaging flange 141 engage with the inner threads 122 of the cap 12 to fix the holder 14 with the cap 12. A cutout 149 is defined in a bottom of the lower engaging flange 141.

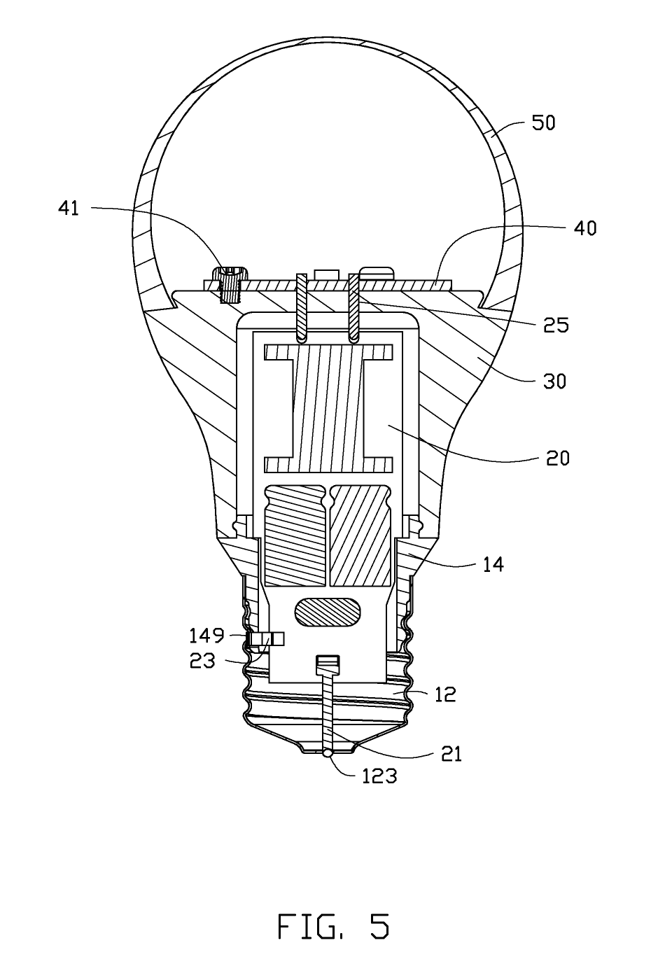

Also referring to FIGS. 4-5, the housing 30 includes a pair of metal frames 34 and a plastic shell 36 molded on the two frames 34. The two frames 34 are spaced from each other by a band 340 of the plastic shell 36. The shell 36 defines a cavity 360 in a bottom face thereof. A plurality of inner threads 362 are formed on an inner circumferential face of the shell 36. The inner threads 362 are located adjacent to a bottom of the shell 36. The inner threads 362 of the shell 36 engage with the outer threads of the upper engaging flange 145 to fix the housing 30 with the holder 14. The shell 36 has a platform 32 protruding upwardly. The two frames 34 are mainly embedded in the shell 36 except top faces thereof. In other words, the top faces of the two frames 34 are exposed outside a top face of the platform 32.

A light source 40 is mounted on the platform 32 of the housing 30. The light source 40 includes a circuit board 400 and an LED 402 mounted on a center of the circuit board 400. The circuit board 400 is disposed on the platform 32 with a bottom face of the circuit board 400 in contact with the top faces of the frames 34. Therefore, heat generated from the LED 402 can be conducted to the shell 36 through the frames 34, and then dissipated to an outside environment. Three screws 41 extend through holes (not labeled) of the circuit board 400 and the top faces of the two frames 34 into the shell 36, thereby fixing the light source 40 with the housing 30.

A driving module 20 is received in the housing 30. The driving module 20 includes a plate 200, a plurality of electrical components 22 mounted on the plate 200 and two upper pins 25 and a lower pin 21 fixed on the plate 200. The electrical components 22 include rectifier, capacitors, resistors. The plate 200 is orientated vertically. A lower portion of the plate 200 is inserted in the two slots 147 of the holder 14 to fix the driving module 20 to the head 10. The lower pin 21 and the upper pins 25 are electrically connected to the electronic components 22 through circuits (not shown) on the plate 200. The lower pin 21 extends downwardly from a bottom of the plate 200, and the upper pins 25 extend upwardly from a top of the plate 200. The upper pins 25 are located just below the band 340 of shell 36 of the housing 30. The lower pin 21 separably contacts the contact tip 123 of the cap 12 to be in electrical connection with the contact tip 123, and the upper pins 25 extend through holes (not labeled) of the band 340 of the shell 36 of the housing 30 and the circuit board 400 to be in electrical connection with the LED 402. An elastic tab 23 is attached on the plate 200 adjacent to the bottom of the plate 200. The tab 23 extends horizontally and laterally from a lateral side of the plate 200. The tab 23 is also electrically connected to the electrical components 22 through the circuits on the plate 200. The tab 23 extends through the cutout 149 of the holder 14 and elastically abuts against the inner circumferential face of the column 120 of the cap 12 so that the tab 23 is in electrical connection with the column 120. Therefore, after the head 10 of the LED bulb 100 is engaged with a typical bulb socket (not shown), power can be input to the driving module 20 through the lower pin 21 and the tab 23 from the bulb socket. The power is then modulated to a suitable driving power for the LED 402 by the driving module 20 and delivered to the LED 402 through the two upper pins 25. As a result, the LED 402 is activated to lighten. During assembly of the driving module 20 to the housing 30 and the head 10, what needs to do is to insert the driving module 20 to the slots 147 of the holder 14, and then threadedly engaging the housing 30 to the holder 14. The electrical connection is thus achieved by contacting the tab 23 and the lower pin 21 with the column 120 and the contact tip 123 of the cap 12, and contacting the upper pins 25 with the light source 40 mounted on housing 30, respectively. Therefore, the electrical connection of the driving module 20 within the LED bulb 100 is convenient and time-saving.

The cover 50 is snapped onto the platform 32 to cover the light source 40. The cover 50 is made of transparent or translucent materials such as plastic or glass. The cover 50 fittingly snaps the platform 32 to be fixed on the housing 30.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An illumination device comprising:
a head comprising an electrically conductive column and an electrically conductive contact tip, the contact tip being electrically insulative from the column, the column forming outer threads thereon;
a housing fixed to the head;
a light source mounted on the housing;
a cover fixed to the housing to cover the light source; and
a driving module received in the housing for modulating external power source to a power source suitable for the light source, the driving module comprising a lower pin separably engaging and electrically connecting the contact tip, a tab elastically engaging and electrically connecting the column and two upper pins electrically connecting the light source.

2. The illumination device of claim 1, wherein the driving module comprises a plate and a plurality of electronic components mounted on the plate, the lower pin, the tab and the two upper pins being electrically connected to the electrical components.

3. The illumination device of claim 2, wherein the lower pin extends downwardly from the plate, and the two upper pins extend upwardly from the plate.

4. The illumination device of claim 2, wherein the tab extends laterally from the plate.

5. The illumination device of claim 2, wherein the tab is elastically deformable.

6. The illumination device of claim 2, wherein the head comprises a cap and a holder threadedly engaging with the cap, the cap comprising the column and the contact tip.

7. The illumination device of claim 6, wherein the lower pin directly contacts the contact tip, and the tab directly contacts an inner circumferential face of the column.

8. The illumination device of claim 6, wherein the holder comprises a base, an upper engaging flange extending upwardly from the base and a lower engaging flange extending downwardly from the base, the upper engaging flange engaging with the housing, and the lower engaging flange engaging with the cap.

9. The illumination device of claim 8, wherein the base defines two opposite slots to receive a bottom of the plate of the driving module therein.

10. The illumination device of claim 8, wherein the lower engaging flange defines a cutout in a bottom thereof, the tab extending through the cutout to contact the column.

11. The illumination device of claim 1, wherein the upper pins extend through the housing into the light source.

12. The illumination device of claim 1, wherein the housing comprises two metal frames and a shell embedding the frames therein, the shell defining a cavity in a bottom thereof to receive the driving module.

13. The illumination device of claim 12, wherein the frames are spaced from each other.

14. The illumination device of claim 12, wherein each of the frames has a top face exposed outside the shell.

15. The illumination device of claim 14, wherein the light source comprises a circuit board and an LED mounted on the circuit board, the circuit board contacting the exposed top faces of the frames.

16. The illumination device of claim 12, wherein the shell is made of an electrically insulative material.

17. The illumination device of claim 12, wherein the shell comprises a platform protruding upwardly, the cover being snapped onto the platform.
